(19) United States
(12) Patent Application Publication
(10) Pub. No.: US 2007/0220047 A1
(43) Pub. Date: Sep. 20, 2007

(54) Systems and methods for reducing stranded inventory

(75) Inventors: Anthony James Barletta, Pickerington, OH (US); Bassel H. Daoud, Parsippany, NJ (US); Maria Karas, Hilliard, OH (US); David B. Philips, Bexley, OH (US); Madhusoodhan Venkatachalam, Lewis Center, OH (US); Christopher K. Wiese, Long Valley, NJ (US)

Correspondence Address: PRIEST & GOLDSTEIN, PLLC, 5015 SOUTHPARK DR, SUITE 230, DURHAM, NC, 27713, US

(73) Assignee: Lucent Technologies Inc., Murray Hill, NJ (US)

(21) Appl. No.: 11/376,504

(22) Filed: Mar. 15, 2006

(51) Int. Cl. G06F 17/00

(52) U.S. Cl. 707/104.1

(57) ABSTRACT

Determining a particular product mix of old and new products to either minimize stranded inventory of old unique sub-components composing the old product or to minimize cost savings by phasing out the old unique sub-components of the old product is described. When a new product costs the same or more than the old product, a product mix which minimizes stranded inventory is determined. To this end, a liability on inventory of old unique sub-components at a number of build out quantities including the total number of product units to produce is determined. Additionally, a number of old products to produce is selected to correspond to a point where the liability on inventory of old unique sub-components is constant between consecutive build out quantities in order to reduce stranded inventory. When a new product costs less than the old product, a product mix which maximizes cost savings is determined. To this end, a liability on inventory of old unique sub-components at a number of build out quantities including the total number of product units to produce is determined. An economic buildout plan which indicates cost savings resulting from replacing the old product with the cheaper new product at the number of build out quantities including the total number of product units to produce is also determined. A number of old products to produce is selected to correspond to the maximum cost savings as indicated by the largest value in the economic buildout plan.

### FIELD OF THE INVENTION

The present invention relates generally to improvements in the field of supply chain management, and, in particular, to systems and methods for reducing stranded inventory when phasing out a product and phasing in a replacement product.

### BACKGROUND OF THE INVENTION

In today's world of outsourcing and off-shoring product manufacturing, managing a business enterprise's supply chain for sub-components of a product is paramount to success in today's global economy. Today's products, such as Internet routers, mobile communication devices, and the like, contain sub-components manufactured by many companies, some of which are located in China, India, and the United States. A new product may be developed to replace an old product for various reasons such as changes in technology, cost, new features, and the like. In some cases, the new product will be manufactured by the same suppliers who manufactured the old product while, in other cases, the new product is manufactured by a combination of new and old suppliers.

Typically, a product or system contains common sub-components that will be used in a new product or system and unique sub-components that will be replaced by other unique sub-components in the new product or system. Due to the varied complexity of sub-components and the varying efficiencies of different manufacturers, sub-components will have different lead times, the amount of time between ordering and delivery of a sub-component. Throughout the manufacturing process, a business enterprise, and in particular a fulfillment group within the enterprise, will manage the timing of when to purchase which sub-components based on their respective lead times in order to deliver complete products or systems.

When introducing a new product which can ultimately replace the existing product, unique sub-components of the old product become stranded when the inventory of the common sub-components are being assembled with the unique sub-components of the new product. In other words, the unique sub-components of the old product are no longer matched with common sub-components. Such stranded inventory may have minimum salvage value but is typically scrapped, resulting in a loss to the business enterprise.

Furthermore, when a new product is being introduced, a design/development team of the business enterprise has its own project schedule for delivering a product that meets customers' requirements. If the unique sub-components for the new product are ordered before the design/development team is ready to deliver a working product, inventory of these sub-components will accumulate costing the business enterprise money. For example, the design/development team may be designing and developing software to execute with the new unique sub-components and if this newly developed software is not completed before the delivery of the new unique sub-components, such unique components will accumulate in inventory. On the other hand, if the unique sub-components are ordered after the design/development team is ready, the delivery of the new product will be simply delayed by a non-technical reason, the sub-component with the longest lead time.

### SUMMARY OF THE INVENTION

Among its several aspects, the present invention recognizes that a particular product mix of old and new products may be determined to either minimize stranded inventory of old unique sub-components, to maximize cost savings by phasing out old unique sub-components of the old product and phasing in new unique sub-components of the new product at a particular time, or to otherwise balance such considerations. When a new product costs the same or more than the old product, one aspect of a method according to the teachings of present invention determines a product mix which minimizes stranded inventory. To this end, the method includes the step of determining a liability on inventory of old unique sub-components at a number of build out quantities including the total number of product units to produce. The method also includes the step of selecting a number of old products to produce corresponding to a point where the liability on inventory of old unique sub-components is constant between consecutive build out quantities in order to reduce stranded inventory.

When a new product costs less than the old product, one aspect of a method according to the teachings of another aspect of the present invention determines a product mix which maximizes cost savings. To this end, the method includes the step of determining a liability on inventory of old unique sub-components at a number of build out quantities including the total number of product units to produce. The method also includes the step of determining an economic buildout plan which indicates cost savings resulting from replacing the old product with the cheaper new product at the number of build out quantities including the total number of product units to produce. The economic buildout plan is a function of the liability on inventory of old unique sub-components at a particular build out quantity. The method also includes the step of selecting a number of old products to produce corresponding to the maximum cost savings as indicated by the largest value in the economic buildout plan. However, the method may alternatively balance cost savings with stranded inventory.

The term “phase-out” as used herein means the timing for shutting off the supply of unique sub-components of a product or system. The term “phase-in” as used herein means the timing for turning on the supply of unique sub-components of a replacement product or system. The term phase-in phase-out (PIPO) as used herein refers to the process and timing involved in phasing-in and phasing-out new and old products or systems.

Another aspect of the present invention recognizes that the timing for shutting off the supply of unique sub-components for the old product and turning on the supply of unique sub-components for the new product is crucial to either reducing the amount of stranded inventory or maximizing cost savings.

Another aspect of the present invention recognizes that coordination between a fulfillment group and a design/development team will reduce unused inventory of new unique sub-components and reduce time delay between the delivery of a new product from the design/development team and the delivery of new product.

A more complete understanding of the present invention, as well as further features and advantages of the invention, will be apparent from the detailed description, the accompanying drawings, and the claims.

### BRIEF DESCRIPTION OF THE DRAWINGS

FIG. 1 shows an illustrative system employing a PIPO system in accordance with the present invention.

FIG. 2 illustrates exemplary software functions of PIPO software 130 of FIG. 1 for determining when to phase-out old sub-components and when to phase-in new sub-components in accordance with the present invention.

FIG. 3 shows an exemplary listing of unique sub-components for the old product in accordance with the present invention.

FIG. 4 shows an exemplary listing of unique sub-components for the new product in accordance with the present invention.

FIG. 5 shows exemplary forecast data for the combined demand of old and new products in accordance with the present invention.

FIG. 6 shows a graph containing the plots of liability on unique inventory and investment in old unique inventory in accordance with the present invention.

FIG. 7 shows an economic build out chart in accordance with the present invention.

FIG. 8 shows a phase-out waterfall diagram based on an analysis of FIGS. 6 and 7 in accordance with the present invention.

FIG. 9 shows a phase-in waterfall diagram based on an analysis of FIGS. 6 and 7 in accordance with the present invention.

FIG. 10 shows a flow chart of a method for determining the phase-out date of old unique sub-components and phase-in date of new unique sub-components in accordance with the present invention.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as methods, systems, or computer readable media. Furthermore, the present invention may take the form of a computer program on a computer-usable storage medium having computer-usable program code embodied in the medium. Any suitable computer readable medium may be utilized including hard disks, CD-ROMs, optical storage devices, flash memories, magnetic storage devices, or the like.

Computer program code or “code” for carrying out operations according to the present invention may be written in an object oriented programming language such as JAVA®, JavaScript®, Visual Basic®, C, C++or in various other programming languages or may be written in the form of a spreadsheet such as one which is run in a Microsoft Excel® or Lotus 123 environment. Software embodiments of the present invention do not depend on implementation with a particular programming language. Portions of the code may execute entirely on one or more systems utilized by a server in the network or a mobile device.

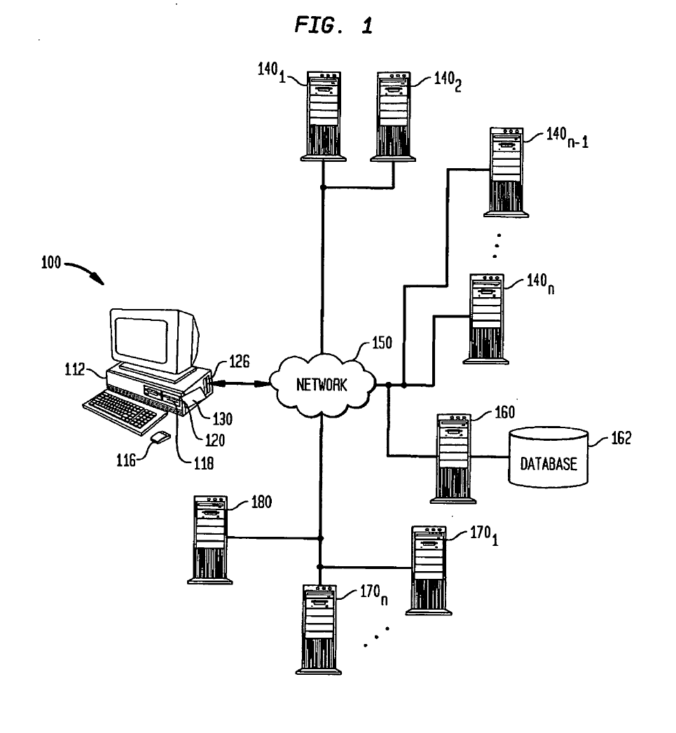

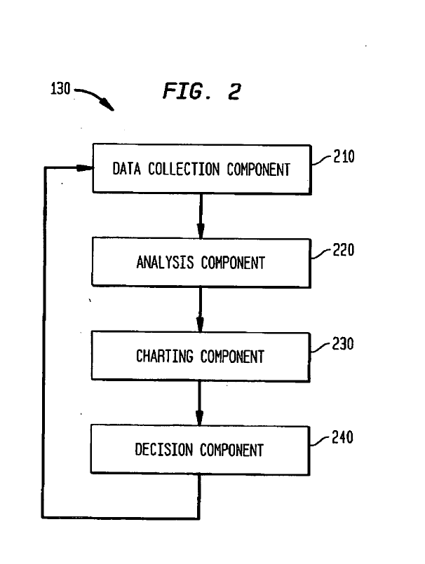

FIG. 1 shows a diagram of a system 100 employing a PIPO system in an environment accordance with the present invention. The illustrated system 100 is implemented as a stand-alone personal computer or workstation 112. As described in further detail below, system 100 includes PIPO software 130 in accordance with the present invention which is stored in memory and run by the central processing unit of the personal computer 112. The presently preferred PIPO software 130 is embodied in an Excel spreadsheet. PIPO software 130 achieves the software functions defined in FIG. 2.

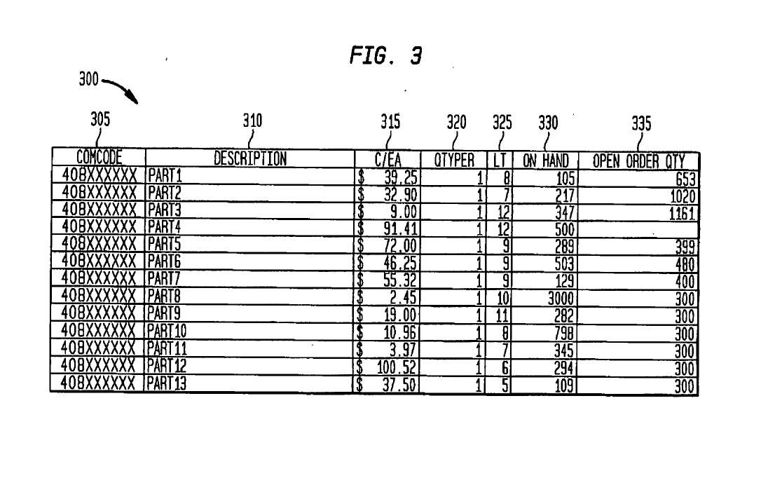

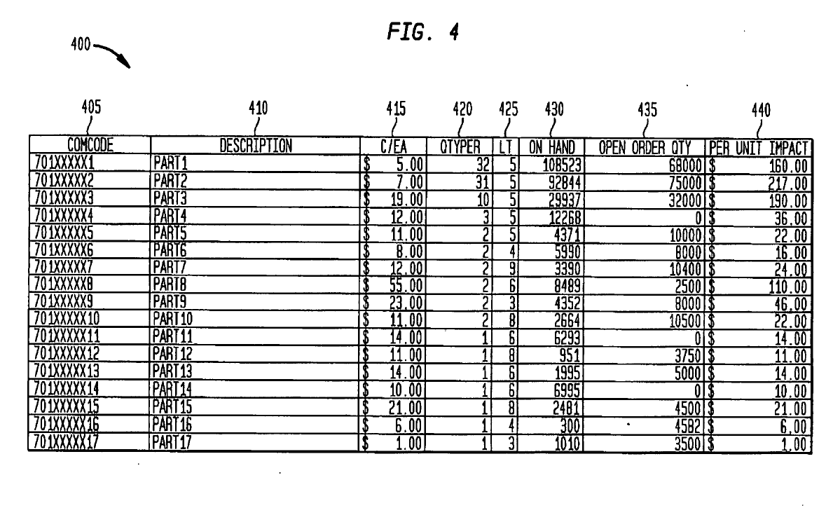

The computer 112 includes a number of standard input and output devices, including a keyboard 114, mouse 116, CD-ROM drive 118, disk drive 120, and monitor 122. Optionally, the computer 112 includes an Internet or network connection 126 to automatically retrieve over network 150 inventory data of sub-components from remote suppliers utilizing known systems such as electronic manufacturer services (EMS), supply chain portal, Webplan®, DataMart® implemented on computing systems 140₁ . . . 140ₙ, respectively, general availability dates for subcomponents from design and development system 180, forecast data from customer systems 170₁ . . . 170ₙ or a sales system 160 containing a database 162 which tracks won and lost contracts. FIGS. 3 and 4 show exemplary inventory information of unique sub-components for old and new product respectively. The network connection 126 may also automatically retrieve over network 150 demand information indicating the demand for a manufactured product.

It will be appreciated, in light of the present description of the invention, that the present invention may be practiced in any of a number of different computing environments without departing from the scope of the invention. For example, the system 100 may be implemented with portions of PIPO software 130 executing on one or more workstations connected to each other over network 150 or a portion of PIPO software 130 may execute on a server while a complementary portion of PIPO software 130 may execute on a workstation networked to the server. Also, other input and output devices such as laptops, handheld devices, or cell phones, for example, may be used, as desired.

One embodiment of the invention has been designed for use on a stand-alone personal computer, laptop, or workstation on an Intel Pentium or later processor, using as an operating system Windows XP, Windows NT, or the like.

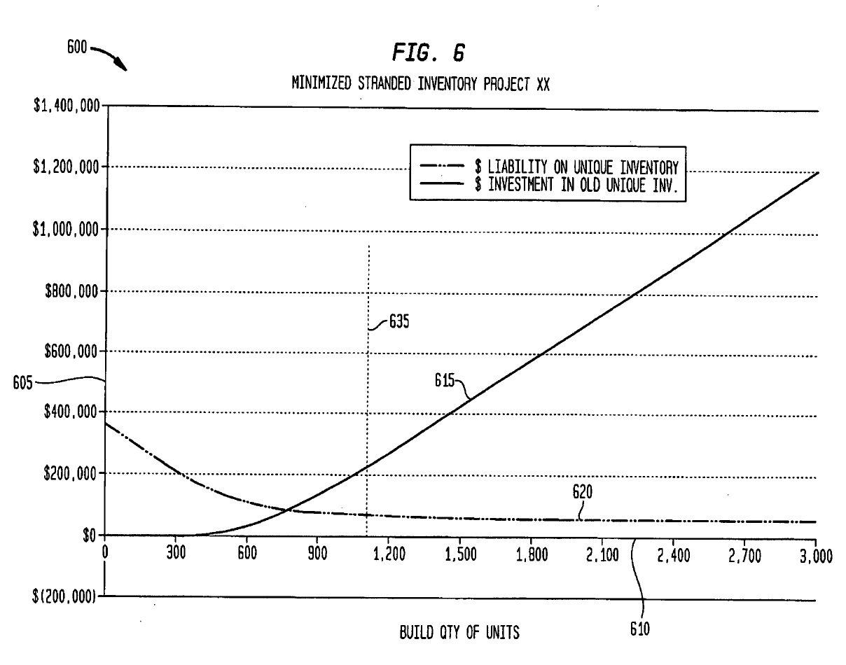

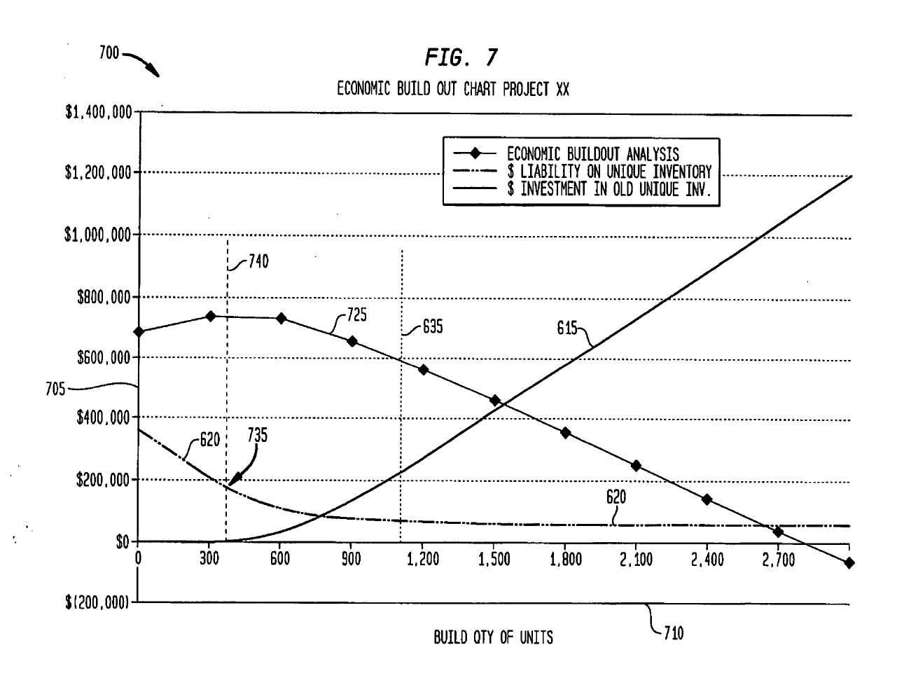

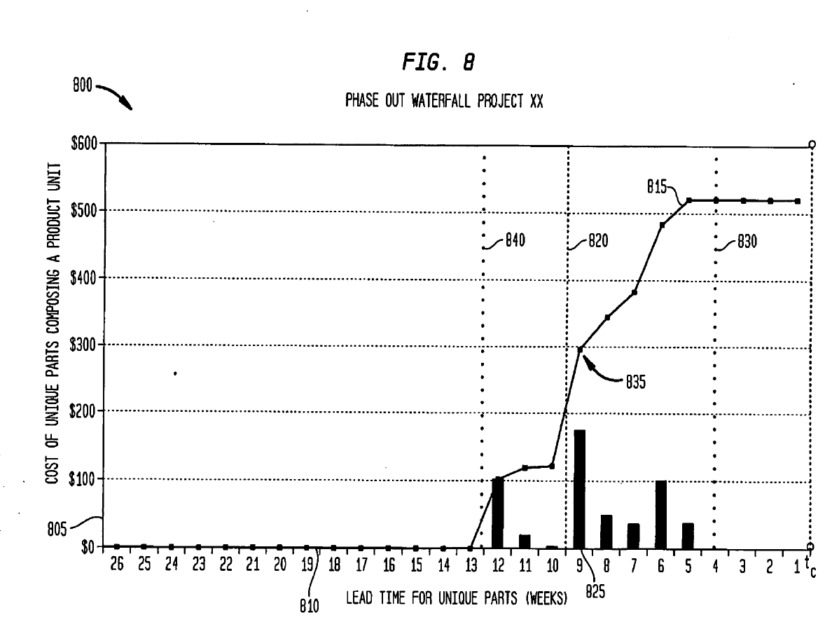

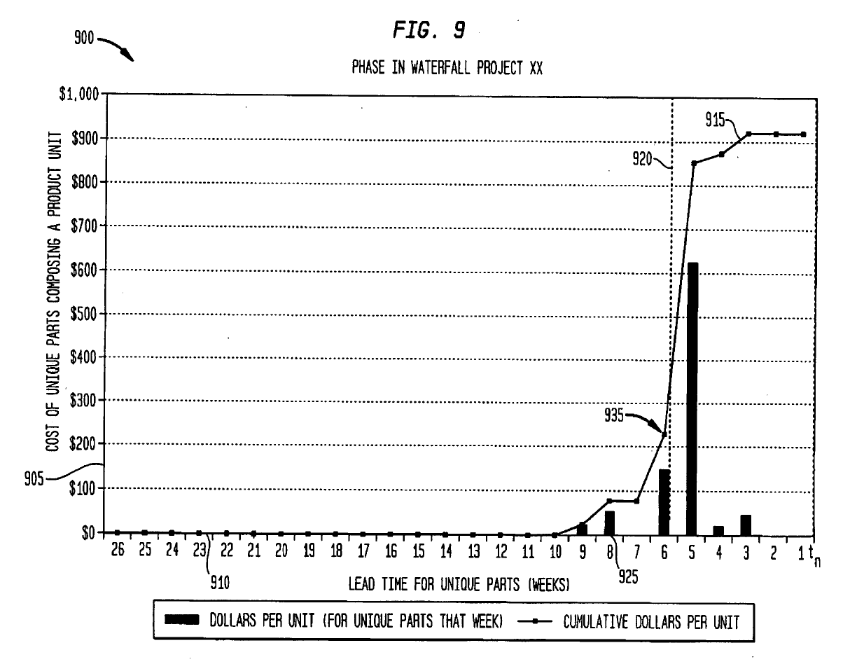

FIG. 2 illustrates exemplary software functions of PIPO software 130 of FIG. 1 for determining when to phase-out old unique sub-components and when to phase-in new unique sub-components in accordance with the present invention. PIPO software 130 includes a data collection component 210, an analysis component 220, a charting component 230, and a decision component 240. PIPO software 130 is iterative in that multiple passes are made through the corresponding software functions in order to keep up with other unplanned activities such as delayed general availability of the new product. Data collection component 210 collects inventory data including unique sub-component costs for the old and new products, forecast and demand data for the old and new products, and the like. This inventory data may be manually inputted to PIPO software 130 or automatically retrieved by PIPO software 130 from known systems such as (EMS), supply chain portal, Webplan®, DataMart®, and the like. FIGS. 3, 4, and 5 illustrated exemplary data which is collected by the data collection component 210. The analysis component 220 calculates cost functions including the cost of old unique sub-components and the amount invested in inventory of old unique sub-components over a variety of numbers of product units built. FIGS. 6 and 7 illustrate charts of plotted cost functions. The analysis component 220 may also include cross referencing inventory data to determine a complete list of unique parts. The chart component 230 optionally creates phase-out and phase-in waterfall charts based on the calculation component 220 according to factors such as minimizing the amount of investment in old unique sub-components, for example. FIGS. 8 and 9 illustrate exemplary phase-out and phase-in waterfall charts based on the calculations of FIGS. 6 and 7. Decision component 240 makes informed decisions such as when to turn off suppliers, when to turn on suppliers of unique subcomponents, whether to delay the general availability date of a new product, and the like. Such decisions are made based on the cost functions and waterfall charts obtained by the analysis component 220 and charting component 230. Method 200 proceeds to step 210 because inventory and demand information change over time.

FIG. 3 shows an exemplary listing 300 of unique sub-components for the old product in accordance with the present invention. Listing 300 includes columns 305, 310, 315, 320, 325, 330, and 335. Column 305 lists the commercial code number for the old product. Column 310 describes the name of a unique corresponding sub-component that is assembled into the old product. Column 315 specifies the cost for each corresponding sub-component. Column 320 specifies the number of a particular sub-component used to assemble one old product. Column 325 specifies the lead time in weeks for ordering a corresponding sub-component from a supplier. Column 330 specifies the number of corresponding sub-components presently in inventory also referred to as “on hand.” Column 335 specifies the number of corresponding sub-components which have been presently ordered and are in the manufacturing pipeline. It should be noted that this inventory information is typically updated on a weekly basis.

FIG. 4 shows an exemplary listing 400 of unique sub-components for the new product in accordance with the present invention. Listing 400 includes columns 405, 410, 415, 420, 425, 430, 435, and 440. Column 405 lists the commercial code number for the new product. Column 410 describes the name of a unique corresponding sub-component that is assembled into the new product. Column 415 specifies the cost for each corresponding sub-component. Column 420 specifies the number of a particular sub-component used to assemble one new product. Column 425 specifies the lead time in weeks for ordering a corresponding sub-component from a supplier. Column 430 specifies the number of corresponding sub-components on hand. Column 435 specifies the number of corresponding sub-components which have been presently ordered and are in the manufacturing pipeline. Column 440 specifies the per unit cost impact on a corresponding sub-component on the new product. For example, Part 1 has a per unit impact of $160 because each part 1 costs $5 and 32 part is are used to make a new product.

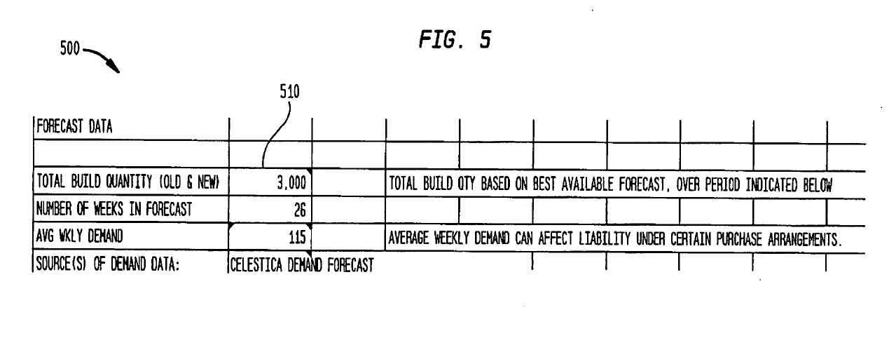

FIG. 5 shows exemplary forecast data 500 for the combined demand of old and new products in accordance with the present invention. At column 510, the forecast data includes the total number of products in demand (3,000) over the next 26 weeks with an average weekly demand of 115 products per week. The number of products in demand is a total of the number of old and new products.

Utilizing the inventory data of FIGS. 3 and 4 and the demand data of FIG. 5, graphs of cost functions are calculated and then alternatively plotted in FIGS. 6 and 7. FIG. 6 is utilized when a new product costs the same or more than the old product.

FIG. 6 shows a graph 600 containing the plots of liability on unique inventory 620 and investment in old unique inventory 615 in accordance with the present invention. The x-axis 610 indicates the total number of product units to be built. The y-axis 605 indicates the amount of money to be spent on old unique sub-components. The liability on unique inventory function 620 and the future investment in old unique sub-components function 615 are plotted on graph 600. As will be described below, these two cost functions will be used to determine the appropriate mix of old product and new product to produce to meet the forecasted demand of 3,000 product units shown in FIG. 3. This technique is referred to as the stranded inventory method and is preferred when a new product cost the same or more than the old product. This situation occurs in many different scenarios such as when a supplier sunsets old sub-component or new enhancements are added to the replacement sub-components.

The liability on unique inventory function 620 or LIA(n) represents the amount of money invested in old unique sub-components at a particular build out quantity n of old product. For each build out quantity of old product n, the LIA(n) function may be calculated by referring to the costs of sub-components in FIG. 3 and applying the following equation:

$$LIA ( n ) = {\sum }_{i = 1}^{s} ( X * {p}_{i} * ( ( {h}_{i} + {o}_{i} ) - ( n * {N}_{i} ) ) + Y * {p}_{i} * w )$$

where s is all the old unique sub-components, pᵢ is the price of the i^{th} sub-component, hᵢ is the on hand inventory of the i^{th} sub-component, oᵢ is the open order inventory of the i^{th} sub-component, Nᵢ is the number of i^{th} sub-component used to make one old product, w is the average weekly demand requirement of a sub-component. X and Y are dummy variables such that X=1 and Y=0, if (hᵢ+oᵢ)−(n*Nᵢ)≧w and X=0 and Y=1, otherwise.

LIA(n) can be calculated by referring to the inventory data of FIG. 3. First, for each part number, the build out quantity of old product is multiplied by the quantity of that part to make one old product and then subtracted from the sum of the on hand inventory 330 and the open order inventory 335 multiplied by the cost of the part and the quantity of the part to make one old product. If that value is greater than or equal to the average weekly requirement for a sub-component which is 115 in this example, that value is then multiplied by the cost of the part and the quantity of the part to make one old product. Otherwise, if that value is less than the average weekly requirement for a sub-component, the cost of the part and the quantity of the part to make one old product is multiplied by the average weekly requirement. Second, the calculations in the first step would be added for each sub-component. For example, if no more old product is to be built, LIA(0) would be $377,774. At a build quantity of 600 old products, LIA(600) would be $108,931.

The investment in old unique inventory function 615 or FIO(n) is the dollar amount of old unique sub-components one will need to purchase in the future to create matched sets with common sub-components to assemble an old product in order to build the desired quantity of old products, n. This investment is calculated by referring to the raw inventory data of FIG. 3 and applying the following equation:

$$FIO ( n ) = {\sum }_{i = 1}^{t} {p}_{i} * ( n * {N}_{i} - ( {h}_{i} + {o}_{i} ) )$$

where t is all the old unique sub-components where the terms (hᵢ+oᵢ)−n*Nᵢ)<0, pᵢ is the price of the i^{th} sub-component, hᵢ is the on hand inventory of the i^{th} sub-component, oᵢ is the open order inventory of the i^{th} sub-component, and Nᵢ is the number of i^{th} sub-component used to make one old product. For example, the future investment in old unique sub-components for building 600 old products, FIO(600) will consist of five part numbers where the term (hᵢ+oᵢ)−n*Nᵢ)<0. These part numbers include part 4, part 7, part 9, part 12, and part 13 because there are not enough of these parts in inventory, on hand and open order, to currently build 600 old product. When multiplying these terms by their respective price and summing the resulting products of each of those part numbers, FIO(600) will equal $21,176. It should be noted that the teachings of the invention contemplate additional types of inventory without limiting the scope of the invention.

After these two cost functions are plotted, it is desired to find the proper mix of old product and new product to produce to minimize the amount of stranded inventory. Referring to the forecast data of FIG. 5, the demand of 3,000 total products in 26 weeks at an average of 115 product units is forecasted. Point 635 on the LIA(n) 620 is used to determine the amount of old products to build. Point 635 indicates the first point where a leveling of stranded inventory costs for old sub-components occurs. Stranded inventory or LIA(n) 620 will level or constant between consecutive build out amounts because there will be some amount of old sub-components that will not be able to match up regardless of the mix of old and new products produced. In other words, all non-unique inventory is being matched up with the unique inventory of new product. In this example, point 635 indicates that approximately 1150 units should be produced of the old product. It should be noted that although the LIA(n) function has leveled at point 635 the future investment in old unique inventory continues to increase after point 635. The increasing nature of the future investment function suggests that the point at which the first leveling of the LIA(n) function is recognized as the amount of old product to produce to minimize cost and minimize stranded inventory. At point 635, the number of old product units to produce out of the 3,000 in the forecast is 1,100 old products. Consequently, the appropriate mix of old and new products to produce to achieve the 3,000 product units is approximately 1,100 old product units and 1,190 new product units.

However, it should be noted that in some situations, such as when new technology is introduced, an old product may be replaced by a new product that costs less than the old product. In those cases, decisions are made utilizing an economic buildout plan.

FIG. 7 shows an economic build out chart 700 in accordance with the present invention. The economic build out chart 700 plots both cost functions 615 and 620 as in FIG. 6, in addition, to a third cost function 725, also referred to as the economic buildout plan or EBO(n). The economic buildout plan 725 represents the cost savings of introducing a new product to replace the old product less the amount of stranded inventory of old unique sub-components. The economic buildout plan 725 or EBO(n) may be expressed as follows:
EBO(n)=(Qₜ−Qₒ)*Sᵤ−LIA(n)
where Qₜ is the total quantity of product units to be made in a time period, Qₒ is the total quantity of old product units, Sᵤ is the per unit savings of producing a new product, LIA(n) is the liability of stranded old sub-component inventory when building n total products as described above.

The economic buildout plan (EBO) function 725 is used when the new product costs less than the old product on a per unit basis. The EBO(n) function 725 is based on a cost savings of $350 per product unit calculated by the differential in costs of a new and old product. If the new product can be produced at a per unit cost savings over the old product, the EBO(n) function 725 is utilized to determine the mix of old and new product which should be produced to meet the forecasted demand of 3,000 product units over 26 weeks at an average of 115 units per week as illustrated in FIG. 5. Line 740 intersect the EBO(n) function 725 at the maximum cost savings when producing a mix of old and new products. Even though the intersection of line 740 with the LIA(n) function 735 is greater than the minimum stranded inventory at point 735, the intersections of line 740 with functions 725 and 735 illustrate that the cost savings on a per unit basis for approximately 380 old products of the 3,000 total product units produced far exceeds the cost of stranded inventory after producing the approximately 380 old product units. At 380 old product units, the cost savings of transitioning between an old to new product is maximized. Consequently, the appropriate mix of old and new product to produce to satisfy the demand of 3,000 product units is approximately 380 old product units and, consequently, 2,620 new product units. The technique for determining the product mix as described above is now referred to as the EBO method. It should be noted that a balance of maximizing cost savings and minimizing stranded inventory may be desired for reasons such as supplier relationships, export/import constraints, and the like. However, the techniques described in connection with FIGS. 6 and 7 allow this balance to be achieved by selecting a product mix within a threshold around the minimum stranded inventory point 735 or leveling point 635.

In the two techniques illustrated in FIGS. 6 and 7, the product mix of old and new products to produce out of the 3,000 total products forecasted has been determined. The output of these methods, the mix of old and new products to produce to achieve the 3,000 total product demand, will be carried forward to determine when to phase-out the supply of the old unique sub-components and phase-in supply of the new unique sub-components. A cutover date is determined by applying the production of old product units to the average weekly demand for products until the number of old products produced match the amount determined by either the EBO method or the stranded inventory method. Since the average weekly demand according to FIG. 3 is 115 weekly units, approximately 3.5 weeks are needed to build 380 old products using the EBO method and approximately 9.5 weeks are needed to build 1,100 old products using the stranded inventory method.

FIG. 8 shows a phase-out waterfall diagram 800 based on an analysis of FIGS. 6 and 7 in accordance with the present invention. The phase-out waterfall diagram 800 has a y-axis 805 defining the cost of unique sub-components to compose a unit of product and an x-axis 810 in lead time in number of weeks. The bars indicate the cost of the amount of sub-components which have to be ordered according to their respective lead time in order to make old product at time t_{c}, the cutover to new product date. Bar 825 indicates the cost of old unique sub-components that require nine weeks of lead time. Referring back to FIG. 3, a group of part numbers, part 5, part 6, and part 7, require a lead time of nine weeks and their total cost is $173.57. Consequently, the height of bar 825 represents $153.57.

Curve 815 indicates the total cost of open orders for old unique sub-components. For example, the sum of cost of sub-components requiring lead times of 9-12 weeks are indicated at point 835 on curve 815. The total amount at point 835 is found by summing costs for part numbers part 3 through part 9 of FIG. 3. The steepest jump in cost is between weeks 10 and 9. At the steepest jump in costs, a fulfillment group responsible for turning off the supply of old unique sub-components should preferably collaborate with the design/development team responsible for designing and developing the new product to make sure that the new product will be ready for delivery within 9.5 weeks. Otherwise, the decision to turn off the supply will have to be delayed.

By way of example, the design/development team may be in the process of developing new software which is to be run on or with the new unique sub-components. If the software is not completely tested or severe defects are not addressed, the new product will not be ready from the design/development team's perspective. Assuming constant demand, the plotted bars and curve 815 will shift right a week for every week delay caused by the design/development team. If, however, the forecast changes, process 200 has to be re-evaluated as indicated by the transition between steps 230 and 210.

Line 820 indicates that approximately 9.5 weeks are needed to build 1,100 old product units as determined by the stranded inventory method above. Since there are bars after the point where line 820 intersects curve 815, suppliers for parts requiring 10, 11, and 12 weeks of lead time can be turned off and suppliers of parts requiring 9 or less weeks may be turned off after their next order. Consequently, line 820 represents the phase-out date for the stranded inventory method and can be found by backing off from the cutover date by the number of weeks it takes to exhaust the number of old products to satisfy demand according to the selected number of old products to produce.

Line 830 represents the approximately 3.5 weeks needed to build 380 old product units as determined by the EBO method. Line 830 represents the phase-out date for the EBO method and can be found by backing off 3.5 weeks from the cutover date. Since line 815 is flat at the point where line 830 intersects it, all the old unique sub-components have been previously ordered. Consequently, all the suppliers supplying old unique sub-components having lead times which are prior to the phase-out date may be turned off. Consequently, utilizing either the stranded inventory method or the EBO method for determining product mix, a determination of when suppliers of old unique subcomponents are turned off is made.

Similarly, suppliers of the new unique sub-components need to be turned on at an appropriate time. FIG. 9 shows a phase-in waterfall diagram 900 based on an analysis of FIG. 7 in accordance with the present invention. The phase-out waterfall diagram 900 has a y-axis 905 defining the cost of unique sub-components to compose a unit of product and an x-axis 910 in lead time in number of weeks. The bars indicate the cost of the amount of sub-components which have to be ordered according to their respective lead times in order to make new product at time tₙ, the date at which new product will be produced instead of old product. For example, bar 925 indicates the cost of new unique sub-components that require eight weeks of lead time. Referring back to FIG. 4, a group of part numbers, part 10, part 12, and part 15, require a lead time of eight weeks and their total cost is $43. Curve 915 indicates the total cost of open orders for new unique sub-components. For example, the sum of costs of sub-components requiring lead times of 9-6 weeks are indicated at point 935 on curve 915. The total amount at point 935 is $226 and is found by summing costs for the part numbers, part 7, part 8, and part 10-part 15, of FIG. 4.

The longest lead time determines when to begin turning on suppliers of new unique sub-components. Referring to the exemplary data of FIG. 4, the longest lead time is nine weeks for part number part 7. Consequently, to meet production of the new product at cutover date, tₙ, the new unique sub-components have to be ordered based on their respective lead times backing up from tₙ. The steepest incline of curve 915 indicates a decision point to determine whether to incur further costs of new unique sub-components in order to produce new product at cutover date, tₙ.

Prior to line 920, design confidence of the new product has to be achieved. In particular, project plans for the development of the new product should be reviewed to make sure that product delivery date or general availability (GA) date coincides with cutover date, tₙ. It should be noted that utilizing the teachings of the present invention, the cutover date, t_{c}, and the new product production date, tₙ, may be substantially equal. It is when these dates are equal that there is no inventory of new unique sub-components awaiting the completion of the design/development team or time delay awaiting new unique sub-components to fulfill a completed design.

To achieve substantially equal dates for t_{c} and tₙ, the charts of FIGS. 8 and 9 preferably may be superimposed. Doing so would reveal that, in the particular example outlined in FIGS. 3-9, line 820 occurs before line 920. Consequently, the collaboration between the fulfillment team and the design/development team should take place prior to line 820. Line 920 may occur prior to line 820 for various situations such as when the lead times of the new unique sub-components are greater than the old sub-components. Utilizing both the phase out waterfall analysis and the phase in waterfall analysis provides the latest date at which to make a purchasing decision of sub-components.

It should be noted that software 130 may perform the analysis as described in connection with exemplary graphs illustrated in FIGS. 6-9 without actually producing corresponding graphs.

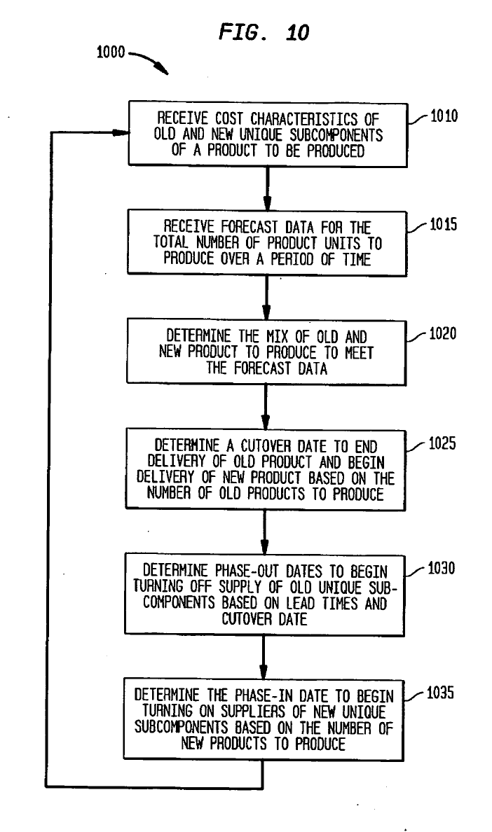

FIG. 10 shows a flow chart of a method 1000 for determining the phase-out date of old unique sub-components and phase-in date of new unique sub-components in accordance with the present invention. At step 1010, cost characteristics of old and new unique sub-components of a product to be produced are received. Exemplary cost characteristics can be found in FIGS. 3 and 4. In step 1010, these cost characteristics may be received as a result of their manual input into software 130 or they may be automatically retrieved from any number of known electronic manufacturing systems. At step 1015, forecast data for the total number of product units to produce over a period of time is received. Exemplary forecast data can be found in FIG. 5. In step 1015, forecast data may be received as a result of its manual input into software 130 or it may be electronically retrieved from forecasting systems. At step 1020, a mix of old and new products to produce to meet the forecasted demand is determined. Step 1020 may be achieved by either the stranded inventory method as described in connection with FIG. 6 or the EBO method as described in connection with FIG. 7. At step 1025, a cutover date to end delivery of old product and begin delivery of new product is determined based on the mix of products to produce. At step 1030, phase-out dates to begin turning off supply of old unique sub-components are determined based on lead times of the old unique sub-components and the cutover date. At step 1035, phase-in dates to begin turning on supply of new unique sub-components are determined based on lead times of the new unique sub-components and the cutover date. If adjustments to the cutover date have to be made, method 1000 proceeds to step 1010 for re-evaluation.

While the present invention has been disclosed mainly in the generic context of sub-components and assembled products, it will be recognized that the present teachings are applicable to all manufactured products such as cell phones, internet protocol (IP) routers, wireless access points, or the like, which contain components manufactured or assembled by multiple suppliers and the timing of which to turn off and turn on these respective suppliers could be advantageously determined using the present teachings.

We claim:

1. A method of determining a product mix of old and new product to deliver which reduces stranded inventory, wherein the new product includes new unique sub-components and replaces the old product, the old product including old unique sub-components, the method comprising:
determining a liability on inventory of old unique sub-components at a number of build out quantities including the total number of product units to produce; and
selecting a number of old products to produce corresponding to a point where the liability on inventory of old unique sub-components is constant between consecutive build out quantities in order to reduce stranded inventory.

2. The method of claim 1 further comprising:
determining a cutover date to end delivery of old products and begin delivery of new products by satisfying the demand for total product with the number of old products to produce until the number of old products to produce have been exhausted.

3. The method of claim 2 further comprising:
determining a phase-out date to begin turning off supply of an old unique sub-component by backing off of the cutover date by the number of weeks it takes to exhaust the number of old products.

4. The method of claim 3 further comprising:
turning off suppliers of old unique sub-components having lead times which are prior to the phase-out date.

5. The method of claim 2 further comprising:
determining a phase-in date to begin turning on supply of a new unique sub-component by backing off of the cutover date by the lead time of the new unique sub-component.

6. The method of claim 2 further comprising:
verifying that the cutover date will be met by a design/development team.

7. A method of determining a product mix of old and new product to deliver in order to maximize cost savings, wherein the new product includes new unique sub-components and replaces the old product, the old product including old unique sub-components, the method comprising:
determining a liability on inventory of old unique sub-components at a number of build out quantities including the total number of product units to produce;
determining an economic buildout plan indicating cost savings resulting from replacing the old product with the new product at the number of build out quantities including the total number of product units to produce, the economic buildout plan is a function of the liability on inventory of old unique sub-components; and
selecting a number of old products to produce corresponding to the maximum cost savings as indicated by the largest value in the economic buildout plan.

8. The method of claim 7 further comprising:
determining a cutover date to end delivery of old products and begin delivery of new products by satisfying the demand for total product with the number of old products to produce until the number of old products to produce have been exhausted.

9. The method of claim 8 further comprising:
determining a phase-out date to begin turning off supply of an old unique sub-component by backing off of the cutover date by the number of weeks it takes to exhaust the number of old products.

10. The method of claim 9 further comprising:
turning off suppliers of old unique sub-components having lead times which are prior to the phase-out date.

11. The method of claim 8 further comprising:
determining a phase-in date to begin turning on supply of a new unique sub-component by backing off of the cutover date by the lead time of the new unique sub-component.

12. The method of claim 8 further comprising:
verifying that the cutover date will be met by a design/development team.

13. A computer readable medium whose contents cause a computer to determine a product mix of old and new products to deliver in order to maximize cost savings, wherein the new product includes new unique sub-components and replaces the old product, the old product including old unique sub-components, by performing the steps of:
determining a liability on inventory of old unique sub-components at a number of build out quantities including the total number of product units to produce;
determining an economic buildout plan indicating cost savings resulting from replacing the old product with the new product at the number of build out quantities including the total number of product units to produce, the economic buildout plan is a function of the liability on inventory of old unique sub-components; and
selecting a number of old products to produce corresponding to the maximum cost savings as indicated by the largest value of the economic buildout plan.

14. The computer readable medium of claim 13 further comprising:
determining a cutover date to end delivery of old products and begin delivery of new products by satisfying the demand for total product with the number of old products to produce until the number of old products to produce have been exhausted.

15. The computer readable medium of claim 14 further comprising:
determining a phase-out date to begin turning off supply of an old unique sub-component by backing off of the cutover date by the number of weeks it takes to exhaust the number of old products.

16. The computer readable medium of claim 15 further comprising:
turning off suppliers of old unique sub-components having lead times which are prior to the phase-out date.

17. The computer readable medium of claim 14 further comprising:
determining a phase-in date to begin turning on supply of a new unique sub-component by backing off of the cutover date by the lead time of the new unique sub-component.

18. The method of claim 14 further comprising:
verifying that the cutover date will be met by a design/development team.
